(19) United States
(12) Patent Application Publication
(10) Pub. No.: US 2018/0298956 A1
(43) Pub. Date: Oct. 18, 2018

(54) METHOD FOR PRODUCING A LAMELLA PACK OF A WET-OPERATED FRICTION CLUTCH AND FRICTION CLUTCH

(71) Applicant: Schaeffler Technologies AG & Co. KG, Herzogenaurach (DE)

(72) Inventor: Stefan Steinmetz, Grünstadt (DE)

(73) Assignee: Schaeffler Technologies AG & Co. KG, Herzogenaurach (DE)

(21) Appl. No.: 15/766,420

(22) PCT Filed: Oct. 7, 2016
(86) PCT No.: PCT/DE2016/200466

§ 371 Date: Apr. 6, 2018

(30) Foreign Application Priority Data
Oct. 21, 2015 (DE) 10 2015 220 463.4

(51) Int. Cl. F16D 13/64; F16D 69/04

(52) U.S. Cl. CPC F16D 13/648; F16D 2069/005; F16D 69/0408

(57) ABSTRACT

A disk pack for a wet-operated friction clutch includes a plurality of friction disks, a plurality of steel disks, and an additive. The plurality of friction disks each include a friction lining on each side. The plurality of steel disks are stacked alternately with the plurality of friction disks. The additive is formed of a polar residue and a nonpolar residue. At least one of the plurality of friction disks or at least one of the plurality of steel disks is treated with the additive prior to an initial startup of the disk pack. The polar residue is attached to the at least one of the plurality of friction disks or the plurality of steel disks. The nonpolar residue is arranged for binding to an operating fluid.

### CROSS-REFERENCE TO RELATED APPLICATIONS

This application is the United States National Phase of PCT Appln. No. PCT/DE2016/200466 filed Oct. 7, 2016, which claims priority to German Application No. DE102015220463.4 filed Oct. 21, 2015, the entire disclosures of which are incorporated by reference herein.

### TECHNICAL FIELD

The present disclosure relates to a method for producing a disk pack and to a disk pack for a wet-operated friction clutch with a plurality of stacked disks forming a frictional engagement under compressive loading in the stack direction, namely friction disks and steel disks bearing a friction lining on both sides, the disk pack being wet-operated in the presence of an operating fluid.

### BACKGROUND

Wet-operated friction clutches are known for many applications, for example in automatic transmissions, dual-clutch transmissions, differentials, belt drives and the like. DE 10 2012 220 892 A1 for example discloses a wet-operated dual-clutch transmission with two friction clutches each with a disk pack with alternately stacked disks on the input and output sides, which under pressure form a frictional engagement between input side and output side by compression of the disk pack. When not under compressive load, the disks on the input and output sides exhibit slippage, such that the frictional engagement is released and the friction clutch is opened. The disks are here divided by type into friction disks and steel disks. The friction disks bear friction linings on both sides, for example of a fibrous material such as paper with reinforcing additives, for example aramid fibers. The friction disks form a friction surface with steel disks, which have a counter-friction surface on both sides relative to the friction surface of the friction disks. The disk pack formed accordingly of alternately stacked friction and steel disks serves, when closed, to transfer the torque applied to the friction clutch. In this case, the torque is transferred via an operating fluid, for example oil, situated between the disks. The film thickness of the operating fluid in this case determines the friction coefficient and the comfort characteristics of the friction clutch. To improve the friction behavior of the disk pack, additives are added to the operating fluid, for example in US 2014/0087982 A1.

### BRIEF SUMMARY

The present disclosure describes a disk pack with improved friction characteristics, which are at least in part independent of the operating fluid used. For example, it is intended to increase the dynamic and/or static friction coefficient of the disk pack. For example, it is intended to optimize the friction coefficient gradient. For example, it is intended to improve the friction coefficient and/or friction coefficient gradient over the service life and/or under heavy load.

### DETAILED DESCRIPTION

The proposed method serves in producing a disk pack for a wet-operated friction clutch with a plurality of stacked disks forming a frictional engagement under compressive loading in the stack direction. The disks are for example formed of friction disks and steel disks bearing a friction lining on both sides and may be stacked alternately in the disk pack. Friction disks may be arranged on the output or the input side in the disk pack. Steel disks may be arranged on the input or the output side in the disk pack. The disk pack is wet-operated in the presence of an operating fluid. The operating fluid may be oil, for example ATF (automatic transmission fluid). Additives may be added to the operating fluid to improve the frictional characteristics of the friction clutch. The additives may be at least components of the at least one additive applied to the disks.

According to the proposed method and the proposed disk pack, at least some of the disks are treated with at least one additive prior to initial start-up of the disk pack. The at least one additive is formed of a polar residue linked, or attached, to the disks and a nonpolar, operating fluid-binding residue. This means that, right from the new state of the disk pack, a preconditioned disk surface is formed which allows the friction coefficient to be improved largely irrespective of the composition of the operating fluid. The operating fluid is held on the disks by means of the at least one additive and thus a defined film predetermined by the characteristics of the at least one additive may be achieved on the surfaces of the treated disks.

The disks may be treated prior to assembly of the disk pack, such that the surfaces of the disks forming the frictional engagement may be deliberately treated. The at least one additive may be applied to the surface of the disks for example using a spraying method, roller-application method, dipping method or the like.

When treating friction disks, the at least one additive may be applied to the friction disk after adhesive bonding of the friction linings applied to both sides of a support disk. In particular applications, the at least one additive may be introduced as early as during production of the paper lining for example from fibers such as for example cellulose fibers, aramid fibers, fillers and resins. For example, the at least one additive may be deposited during or after production of the friction lining by means of microcapsules in the friction linings. Activation of the at least one additive is set for a later point after deposition, for example by destruction or dissolution of the microcapsules for example by mechanical loading or elevated temperature.

When treating steel disks, at least the surface may be activated as a counter-friction surface of the steel disks prior to application of the at least one additive, in order to achieve better adhesion of the at least one additive. For example, the surface roughness may be set as peak-to-valley height off-tool or in subsequent machining to improve adhesion of the at least one additive. Alternatively or in addition, the surface may for example be pretreated by plasma treatment, laser treatment or the like. Alternatively or in addition, the surface may be chemically activated for example by means of an acid pickling method, alkaline pickling method or the like.

For improved application of the disks, the latter may be subjected to heat treatment before, during and/or after application of the at least one additive to a friction and/or steel disk. For example, a temperature program with low temperatures, for example room temperature, may be applied during application of the at least one additive. After application of the additive, the temperature may be raised for example to or above the working temperature of the disk pack, for example for conditioning, bond formation and the like.

The at least one additive may be applied to the disks in liquid form or as a solution. If the at least one additive is applied in solution, the solvent may proceed by evaporation of the solvent under ambient conditions, at elevated temperature and/or under reduced pressure.

The at least one additive may be used from a single chemical compound or as an additive mixture of a plurality of chemical compounds active as additives. At least one additive should be understood also to mean the addition of added substances, for example for stabilizing the at least one additive.

The disk pack is provided for a wet-operated friction clutch, for example a single friction clutch provided between internal combustion engine and transmission, a dual clutch with two friction clutches for a dual-clutch transmission, a clutch in an automatic transmission, a synchronous clutch coupling between the shafts of an all-wheel drive vehicle, a differential clutch, a converter lockup clutch, a hybrid clutch between internal combustion engine and electrical machine or the like. The disk pack includes a plurality of stacked disks forming a frictional engagement under compressive loading in the stack direction, namely friction disks and steel disks bearing a friction lining on both sides. At least some of the disks are treated in the new state of the disk pack with at least one additive. The at least one additive is formed of a polar residue linked to the disks and a nonpolar, operating fluid-binding residue.

The polar residue of the at least one additive may contain a functional ether, ester, amine, amide and/or thiol group. The nonpolar residue of the at least one additive may include an organic alkyl and/or aryl residue. Long, optionally branched organic residues may for example be provided, which for example form nonpolar interactions with the operating fluid.

The at least one additive may include components at least from one of the following classes of substances:
fatty acids, in particular long-chain fatty acids, in particular fatty acids with a branched organic residue,
fatty acid esters,
amino fatty acids,
amido fatty acids,
imido fatty acids,
phosphoric esters,
thiophosphoric esters,
sulfur-containing fatty acids, in particular thiols, or thioethers and/or thioesters,
organometallic thiophosphates.

In other words, by a suitable selection of additives, the surface of the friction disk and/or of the steel disk may be lined right from new. This means that, through appropriate treatment of the friction and/or steel disk, the respective surfaces may be conditioned with the functional characteristics of the additive(s) by means of adsorption or absorption. The additives here have the task of sticking with the polar molecular moiety as residue to the respective friction lining surface of the friction disks or to the steel disk surface and, as a result of the nonpolar long-chain moiety, forming a kind of “molecular brush” thereon. This has the function of avoiding solid-to-solid contact between the disks even in the case of an operating fluid of low thicknesses, such as oil film thicknesses. Branching of the nonpolar residue may interact with the operating fluid and, as a result of the more highly branched “molecular brush”, bind a relatively large quantity of operating fluid for example van der Waals forces. In this way, the thickness of the operating medium film and thus the friction coefficient of the disk pack may be increased. For the friction disks, the additives may be applied to or introduced into the material of the friction linings by spraying, roller coating or dipping after the process of adhering the friction linings to a support disk. Prior to application of the additive(s), the surface of the friction disk, i.e. the lining surface thereof, may be modified, for example by means of heat treatment, with regard to its absorption capacity for the additive(s).

The additives may likewise be applied to or introduced into the steel disk by the stated methods. For example, activation of the steel disk surface may be provided, for example by an acid pickling process, prior to wetting with additives.

Likewise, subsequent heat treatment of the steel or friction disks after application of the additives may prove advantageous. This enables a more intense reaction of the additives with the respective surfaces to be achieved. The classes of substances substantially consist of a polar moiety and a nonpolar moiety. The polar moiety may assume the function of “docking” to the friction and/or steel disk surface. The long-chain nonpolar moiety may constitute a “molecular brush” and bring about interaction with the operating fluid of the disk pack and/or a transmission oil or the like. To increase the effect, it may be meaningful to provide the per se nonpolar residue, i.e the residue not provided for bonding to the surfaces of the disks, for example in the form of a long linear or branched organic residue, with more highly polar characteristics by incorporating ether, amine, amide and/or mercaptan functional groups.

The additives may be applied to the disks in liquid form and a suitable solvent system.

In another variation, provision may be made for encapsulating the additives in a material which may on the one hand be used as a starting material for producing a friction lining and/or the preliminary paper stage thereof and for example become active at higher surface temperatures.

1.-10. (canceled)

11. A disk pack for a wet-operated friction clutch comprising:
a plurality of friction disks each comprising a friction lining on each side;
a plurality of steel disks stacked alternately with the plurality of friction disks; and,
an additive formed of a polar residue and a nonpolar residue, wherein:
at least one of the plurality of friction disks or at least one of the plurality of steel disks is treated with the additive prior to an initial startup of the disk pack;
the polar residue is attached to the at least one of the plurality of friction disks or the at least one of the plurality of steel disks; and,
the nonpolar residue is arranged for binding to an operating fluid.

12. The disk pack of claim 11 wherein the polar residue comprises at least one of a functional ether, an ester, an amine, an amide, or a thiol group.

13. The disk pack of claim 11 wherein the additive comprises at least one of a long-chain fatty acid, a fatty acid ester, an amino fatty acid, an amido fatty acid, an imido fatty acid, a phosphoric ester, a thiophosphoric ester, a sulfur-containing fatty acid, or an organometallic thiophosphate.

14. The disk pack of claim 13 wherein the additive comprises the sulfur-containing fatty acid and the sulfur-containing fatty acid is a thiol, a thioether, or a thioester.

15. A method for producing the disk pack of claim 11, wherein the at least one of the plurality of friction disks is treated prior to alternately stacking with the plurality of steel disks.

16. A method for producing the disk pack of claim 11, wherein the at least one of the plurality of steel disks is treated prior to alternately stacking with the plurality of friction disks.

17. A method for producing the disk pack of claim 11, wherein treating with the additive includes applying the additive using a process selected from the group consisting of: spraying, roller-application, and dripping.

18. A method for producing the disk pack of claim 11 comprising:
adhesively bonding the friction lining to each side of the at least one of the plurality of friction disks; and,
treating the at least one of the plurality of friction disks with the additive after the friction linings are adhesively bonded.

19. A method of producing the disk pack of claim 11 comprising:
chemically activating the at least one of the plurality of steel disks; and,
treating the at least one of the plurality of steel disks with the additive after it is chemically activated.

20. A method for producing the disk pack of claim 11 wherein:
the at least one of the plurality of friction disks or the at least one of the plurality of steel disks is subjected to a heat treatment before, during, or after being treated with the additive.

21. A method for producing the disk pack of claim 11 wherein the additive is a liquid or a solution during treating.
